(19) United States
(12) Patent Application Publication
(10) Pub. No.: US 2010/0223472 A1
(43) Pub. Date: Sep. 2, 2010

(54) METHOD AND SYSTEM FOR LEGALLY SHARING FILES

(75) Inventor: Peter Alvarsson, Lidingo (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: HEADWEB AB, Stockholm (SE)

(21) Appl. No.: 12/664,228

(22) PCT Filed: Jun. 13, 2008
(86) PCT No.: PCT/SE08/00396

§ 371 Date: Feb. 22, 2010

(30) Foreign Application Priority Data
Jun. 13, 2007 (SE) 0701443-4

(51) Int. Cl. H04L 9/32; G06F 21/24

(52) U.S. Cl. 713/176

(57) ABSTRACT

The invention relates to a method and a system for distributing a content item, which has been divided into a plurality of blocks of data. A control unit creates at least one watermark block. This watermark block is unique for the client and the content item to be distributed and is stored in a watermark unit. Before the content item is distributed to the client the client will need a ticket in order to verify himself when connecting to other clients. The clients can, if they have valid tickets, connect to each other and transfer the blocks of data to and from each other. In order for a client to receive a complete content item it also needs to connect to the watermark unit in order to obtain the at least one watermark block that makes the content item complete.

### TECHNICAL FIELD OF THE INVENTION

The present invention relates to a method and a system for distribution of content over a peer-to-peer network to authorized nodes only.

DESCRIPTION OF RELATED ART

Today more and more people use the Internet to distribute or download files. The most common method by which files are transferred on the Internet is the client-server model. A central server sends the entire file to each client that requests it. The clients only speak to the server, and never to each other, i.e. it is a point-to-point connection. The main advantages of this method are that it is simple to set up, and the files are usually always available since the servers tend to be dedicated to the task of serving, and are always on and connected to the Internet. However, this model has a significant problem with files that are large or very popular, or both. It takes a great amount of bandwidth and server resources to distribute such a file, since the server must transmit the entire file to each client.

Another method of transferring files that have become popular is the use of a peer-to-peer network, with techniques such as Kazaa, eDonkey, Gnutella, Direct Connect, etc. In most of these networks, ordinary Internet users trade files by directly connecting one-to-one. The advantage here is that files can be shared without having access to a proper server, and because of this there is little accountability for the contents of the files. Hence, these networks tend to be very popular for illegal files such as music, movies, pirated software, etc.

A widely spread content distribution system is a technique called BitTorrent. BitTorrent is a file sharing protocol for efficient distribution of large files over the Internet. It is peer-to-peer in nature, as users connect to each other directly to send and receive portions of the file. However, there is a central server called a tracker, which coordinates the action of all such peers. The tracker only manages connections, it does not have any knowledge of the contents of the files being distributed, and therefore a large number of users can be supported with relatively limited tracker bandwidth. The key philosophy of BitTorrent is that users should upload (transmit outbound) at the same time they are downloading (receiving inbound.) In this manner, network bandwidth is utilized as efficiently as possible. BitTorrent is designed to work better as the number of people interested in a certain file increases, in contrast to other file transfer protocols.

In order for BitTorrent to work and coordinate the downloading and uploading each peer or client needs to download a torrent, which is a metadata file containing information about all the files that it makes downloadable, including their names and sizes and checksums of all pieces in the torrent. It also contains the address of a tracker that coordinates the communication.

U.S. Patent application no. 2006/0206486 describes a method and a system for legally sharing files in a peer-to-peer network on the Internet. The method is focused on incentive programs, which allow users to earn credits for later use. This invention is also concerned with verifying that the files that are shared are authorized files. However, how the verification of clients that are connected to the peer-to-peer network is done is not clear.

European patent application no. 05105865.9 describes a content distribution method with the aim to maximize the delivery throughput in a peer-to-peer network. This is done by assigning content to the nodes based on the capacity of each node.

WO 2005/112334 describes a method and a system for secure distribution of content over a communications network. The content owner distributes the content broken down into blocks to one or more content sources, which serve as distribution points for a subscriber. A subscriber requesting a content item from a content owner receives a list of content sources with available blocks of the content item. In addition, a subscriber may determine if any peers on a peer-to-peer network to which the subscriber belongs also has any of the blocks of the content item available.

Thus, today there are several efficient methods for distribution content items over the Internet. However, the major problem is that these methods almost solely are used illegally, i.e. the legitimate owner of the original content item has not given his or her consent to download it. There are some legal file sharing sites today, but they have the drawback of distributing copy-protected content, which restricts the way a client can use the file.

Thus, there is a need for a system and a method that uses these efficient methods for distributing content on a legal basis. In order to do so it is important that peers in a peer-to-peer network can verify that they have the right to download content from each other. Furthermore, it is important that a downloaded file is traceable. If a downloaded file is unique for the client who has downloaded it, it will probably prevent the client from distributing illegal copies thereof.

### SUMMARY OF INVENTION

It is an object of the present invention to provide a method and a system for facilitating legal distribution of content items, which have been divided into a plurality of blocks of data, to at least one client using a peer-to-peer network. It is also an object of the invention to improve the security and the traceability during and after a content item is distributed to a client in a peer-to-peer network.

According to one aspect of the present invention there is provided a method for distributing a content item, in which at least one watermark block is created that is unique for the client and the content item to be distributed. The method further comprises issuing a ticket to the client, which ticket makes it possible for the client to verify himself when connecting to selected clients identified on a list that has been sent to the client. When connected, blocks of data are transferred from the selected clients to the client. The watermark block is also transferred to the client from a dedicated storage unit.

According to a second aspect of the present invention the step of creating at least one watermark block comprises assigning at least one of the blocks of data to be a watermark, dividing the at least one watermark block into a plurality of watermark pieces, and adding a unique watermark to each watermark piece.

According to a third aspect of the present invention there is provided a system for distributing a content item, which has been divided into a plurality of blocks of data, to at least one client connected to a peer-to-peer network. The system comprises a control unit for creating the at least one watermark block that is unique for the client and the content item, a dedicated storage unit for storing the watermark block, a ticket granter for issuing a ticket to the client, a tracker for identifying other clients that also are interested in receiving the content item.

### BRIEF DESCRIPTION OF THE DRAWINGS

Further objects, features, and advantages of the invention will appear from the following description of several embodiments of the invention, wherein various aspects of the invention will be described in more detail with reference to the accompanying drawings, in which:

FIG. 1, shows a system for distributing a content item according to the present invention,

FIG. 2, shows how a content item is divided into a plurality of data blocks and watermark blocks and how each watermark block is divided into a plurality of watermark pieces, and

FIG. 3 shows a communication table explaining the basic method according to the present invention.

### DETAILED DESCRIPTION OF THE INVENTION

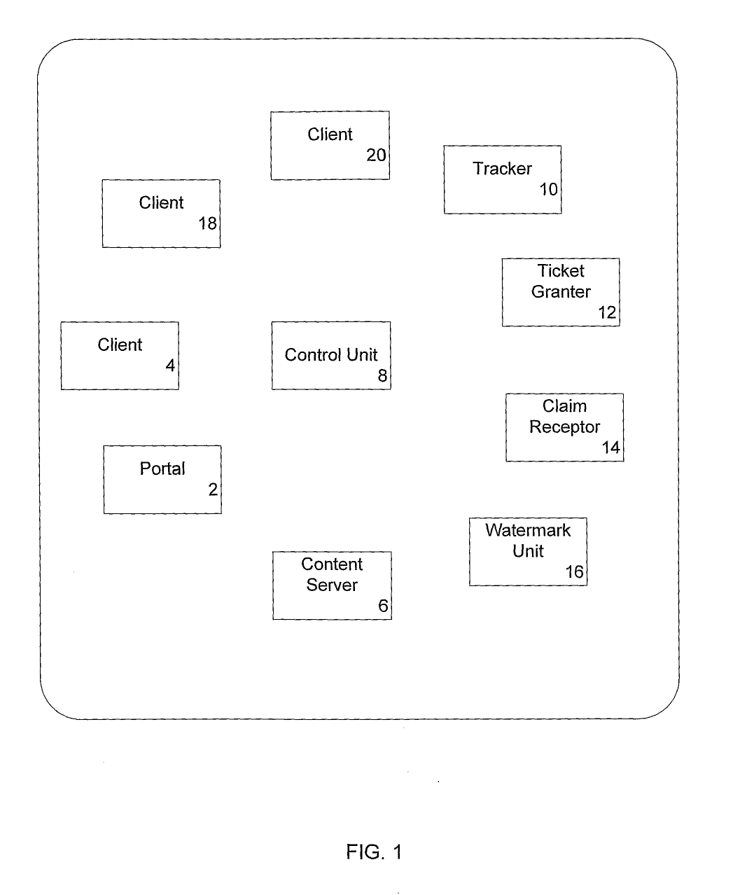

FIG. 1 illustrates a system for distribution of content over a peer-to-peer network to authorized nodes only. The system comprises a portal 2, usually a website, to which a client 4 may connect. Furthermore, the system comprises a content server 6, a control unit 8, a tracker 10, a ticket granter 12, a claim receptor 14, a watermark unit 16 and further clients 18 and 20.

The portal 2 can be set up us a member site requiring a login in order for a client 4 to get access to the content of the site or it may be available to anyone. The portal is the user interface for a client 4 wanting to purchase a content item. In context of the present invention it should be understood that a content item might include any type of digital content such as, movies, videos, music, e-books, games etc. Furthermore, a content item may be stored in one single file or in multiple files. The portal 2 shows the contents available for a client 4 to purchase. Once the client 4 has decided what to purchase, he clicks a “buy button”. The portal 2 will then ask the client 4 to enter information about how he will pay. The portal 2 sends this information to the control unit 8 that processes this information in order to approve or disapprove this transaction.

If the control unit 8 approves the transaction, it will send an approval back to the portal 2 and the client 4 will be provided with a so-called “info-hash”. The info-hash is a unique ID containing the name of the file (content) to be downloaded in form of a checksum.

In order to know where to start downloading the client 4 connects to the tracker 10 and communicates the info-hash to the tracker 10 that corresponds to the purchase made by the client. The tracker 10 responds thereto by sending a list identifying other clients 18, 20 that have purchased the same content item and that are connected to the peer-to-peer network. It should be noted that even if this example and FIG. 1 only mention and show two other clients the number of clients could be any number. The more clients connected to the peer-to-peer network the faster the downloading time usually is. The identifying list also identifies a content server 6, acting as a client, having a complete copy of the content item, or almost the complete copy, as will be described further below. The content server 6 is usually provided by the service provider who set up the portal 2. This is done in order to always have an available copy for downloading in the peer-to-peer network, regardless if there are any other clients connected to the network at the time.

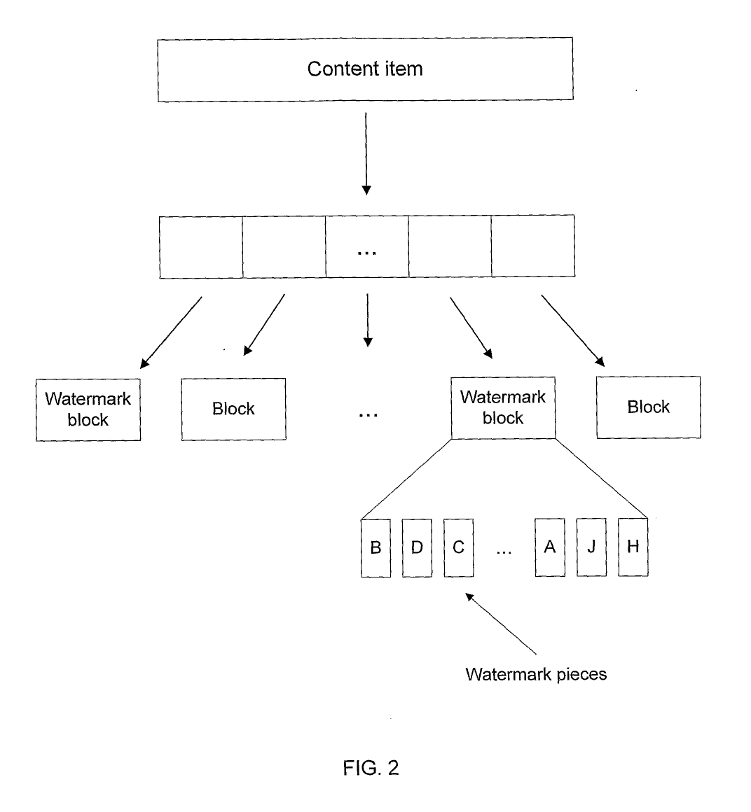

When the content item first is uploaded on the content server 6 it is divided into a plurality of content blocks of data as can be seen in FIG. 2. Each block typically has a size of 1-2 MB. The size of a typical movie is 1-4,5 GB, which gives a total of 1000-2000 data blocks for one movie. At least one of these blocks of data is assigned to be a watermark block. A watermark block is in turn divided into a plurality of watermark pieces. A unique watermark will be added to each watermark piece. This addition of unique watermarks will be made individually for the client 4 each time he purchases a new content item.

When a purchase has been made and the control unit 8 has approved this transaction, as mentioned above, the control unit 8 will create the unique watermark for each watermark piece and save it on the watermark unit 16 for later retrieval of the client 4. Thus, as mentioned above almost the complete file is stored on the content server 6, the exception being the at least one watermark block. In a preferred embodiment of the invention a new watermark block is created for each 10 minutes of a movie. Thus, for a normal full-length movie of around 100 minutes there will be 10 different watermark blocks. Preferably, each watermark block comprises 10 to 30 different watermark pieces. In a preferred embodiment of the invention each watermark piece can bet set either to a logical “0” or a logical “1”. In a preferred embodiment of the invention , in which 20 watermark pieces are used, this will give over 1 million combinations for a watermark block if logical “1” and “0” are used. For a full-length movie having around 10 watermark blocks the combinations are almost unlimited. As mentioned above it is the control unit 8 that is responsible for the creation and the setting of the watermark block, which is stored on the watermark unit 16.

The creation of the watermark block could in alternative embodiment of the invention be made in another way. Thus, in this embodiment a set of watermark pieces are already set and stored on the watermark unit 16. The creation process performed by the control unit 8 then comprises the selection of a combination of watermark pieces that make up the watermark block, connected to a specific client 4 and purchase. The use of watermarks will secure that each individual purchase that is made through the portal 2 can be traced through its unique ID.

Thus, at least one watermark block has now been created and stored on the watermark unit 16 and the client 4 has now also received a list identifying other clients 18, 20 that have purchased the same content item. But, before the client 4 can start downloading from other clients 18, 20 the client 4 will need a ticket in order to be verified by other clients 18,20. The client 4 will need to contact the ticket granter 12 and request a ticket. The client 4 sends the above mentioned info-hash to the ticket granter 12. The ticket granter 12 will in turn contact the control unit 8 in order to check that the client 4 has made a legal purchase according to what is specified in the info-hash.

If the client is approved by the control unit 8, the ticket granter 12 will receive this information and the ticket granter 12 will in turn send a receipt, including a valid ticket, to the client 4. At first this ticket will be valid both for downloading and uploading. But, as soon as the client 4 has downloaded the complete content item, the client 4 contacts the ticket granter 12 once again, and the ticket granter 12 will issue a new ticket for the client 4, which is valid only for uploading. The ticket granter 12 will, of course, first make a check with the control unit 8 if it is allowed to issue a new ticket.

In context of the present application it should be noted that a ticket could be anything that can identify a client in a secure and safe way. For example a ticket can be an encrypted key or the like. There, are many authorization techniques available for a person skilled in the art and it is therefore not described in detail here.

Once the client 4 has obtained a valid ticket he is free to contact other clients 18, 20, which are identified on the list previously obtained by the tracker 10. A contact between two clients always starts with the exchange of tickets in order to verify each other. It is first after this verification of each other that the downloading and uploading between clients can take place. This is of course an important feature in order to secure that no illegal file sharing is taking place. Only clients that have made a legitimate purchase are able to share files with each other.

The client 4 can download the content item from all clients 18, 20 on the identifying list and also from the content server 6, which also is on the identifying list. However, the client cannot download the complete content item from other clients 18, 20 or the content server 6, since it also needs the at least one watermark block that is stored on the watermark unit 16. The client 4 will request the at least one watermark block from the watermark unit 16. When the watermark unit 16 receives the request it first checks if the client 4 has a valid ticket. In order to do so the watermark unit 16 contacts the control unit 8, which verifies the ticket and if it is valid returns information to the watermark unit 16 about which unique watermark block this individual client 4 shall download. The watermark unit 16 then uploads this watermark block to the client 4. This is a very important feature, which makes it possible to trace the origin of the file. If for example the client 4 decides to share his legally obtained file in an illegal file sharing network it will be easy to check that it was just this individual client 4 that started to share the file illegally.

Different peer-to-peer techniques can be used in order to download and upload the content item. In one preferred embodiment of the invention a variation of BitTorrent is used. The BitTorrent protocol has according to the preferred embodiment been provided with extra functionality, which is to be described below.

In one preferred embodiment of the present invention clients 4, 18, 20 that upload data to other clients 4, 18, 20 will earn credits. This is a way for a service provider to encourage clients to upload data and thereby increase the availability of the files to be downloaded. Thus, when a client 4 has downloaded a complete content item, the clients 18, 20 that have uploaded the data blocks to the client 4, will contact the claim receptor 14 and claim credits for the uploaded data. Also, the client 4 will contact the claim receptor 14 and report how much and from which clients 18, 20 he has been downloading. The claim receptor 14 will keep track of all claims and also check if they are valid claims, by comparing uploading and downloading information from the clients. It should be noted that each time a client contacts the claim receptor 14 it has to show a valid ticket in order to start communication there in between. This is also true for all communication between clients and all units included in the system according to the present invention, such as the watermark unit 16, the content server 6 etc.

In another embodiment of the invention the claiming of credits are performed before the client 4 has downloaded the complete file. Thus, preferably the clients 4, 18, 20 contact the claim receptor 14 every 5 minutes to make a claim. The advantage with making these claims more often is that it gives a faster detection of fraudulently behaviour.

As mentioned above, the workflow of downloading and uploading between the clients is coordinated by using a torrent. Compared to BitTorrent, the torrent used in preferred embodiments of the present invention comprises added functionality in regard of coordinating the downloading of watermark blocks and also in regard of the claiming of credits and the use of tickets to verify that clients are legitimate.

Furthermore, it should be understood that the system described above has been described according to preferred embodiments. Even if FIG. 1 shows for example the ticket granter 12 and the claim receptor 14 in separate boxes it does not mean that the software thereof is stored physically on separate units. FIG. 1 only shows that these are two different applications, which may or may not run on the same computer. However, the clients 4, 18 and 20 depicted in FIG. 1 are separate physical units.

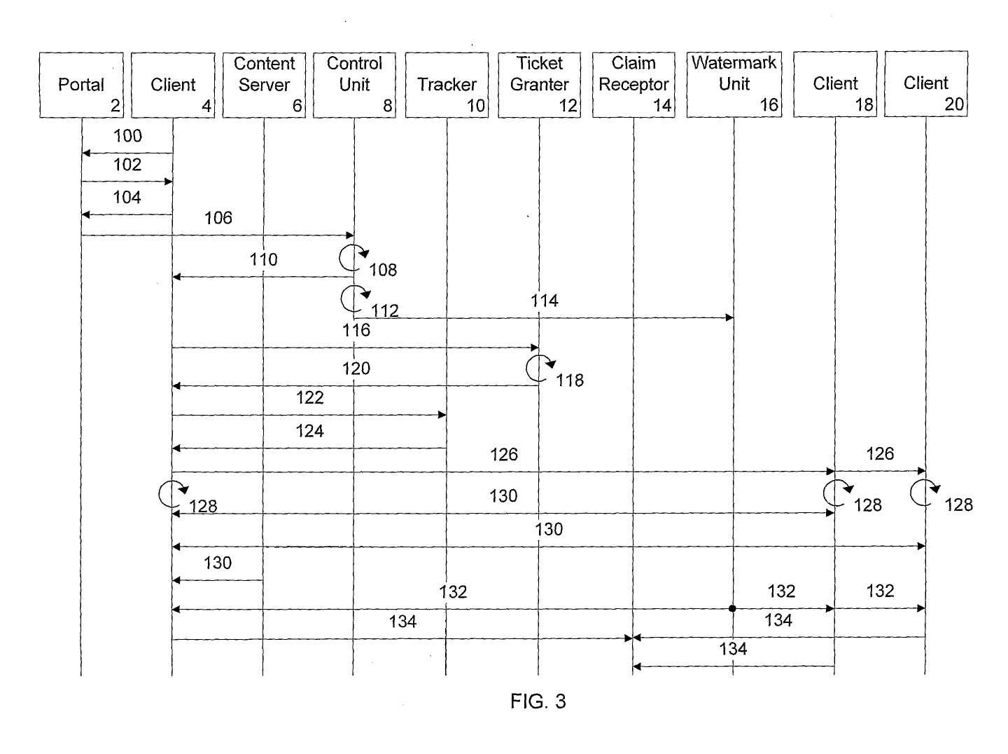

FIG. 3 shows a table with the applications and units depicted in FIG. 1. In the table an arrow shows that communication takes place between two or more units or applications. A circular arrow shows that there is an ongoing process run by the unit or by the application. The table also shows a time dimension by that the further down you go in the table the more time has elapsed. For example, the communication for the arrow in step 102 occurs prior to that of the arrow in step 122.

As described above it all starts at step 100, with the client 4 connecting to a portal 2 and making a purchase. The portal 2 responds by sending a request for payment information in step 102. The client 4 responds thereto and sends the payment details to the portal 2 in step 104. The portal 2 in turn, connects to the control unit 8 and forwards the payment information to the control unit 8 in step 106. In step 108, the control unit 4 processes this information (purchase request) and approves or disapproves the purchase. If the purchase is disapproved the process will come to an end. However, if the purchase request is approved the control unit 8 will send the info-hash to the client 4 in step 110.

Thereafter in step 112, the control unit 8 will start creating 112 the watermark, which is unique for the client in combination with the purchase in question. After this process is ready the control unit will, in step 114, send the watermark to the watermark unit 16 for storage.

The client 4 will use the info-hash received from the control unit 8 to get a ticket that will allow him to start downloading. Thus, the client 4 sends, in step 116, the info-hash to the ticket granter 12. In step 118, the ticket granter 14 processes the request for a ticket and approves or disapproves the request. This step 118 may involve, even if it is not explicitly shown in the table, that the ticket granter 12 connects to the control unit 8 in order to verify that the client 4 has made a valid purchase. Disapproval will end the process and an approval will, in step 120, trigger the sending of a ticket to the client 4.

The client 4 will also send the info-hash to the tracker 10, in step 122. This step does not have to be performed after the above described steps 116-120 for requesting a ticket. It could be done in parallel or even prior to the ticket request. In step 124, the tracker 10 will after receiving the info-hash send a list back to the client 4 identifying other clients 18, 20 in the peer-to-peer network that also purchased the same content item. The client 4, now having the list, can in step 126 connect to other clients 18, 20. Before downloading and uploading can be performed the client 4, in step 128, needs to verify 128 the other clients 18, 20 and the other clients 18, 20 need to verify 128 the client 4. If the clients 4, 18, 20 verify each other the process continues and the clients 4, 18, 20 start uploading and downloading to and from each other, in step 130. As can be seen in FIG. 3 the client 4 can also download from the content server 6, which has a complete file of the content item, except for the watermark pieces as discussed above. The watermarks are downloaded from the watermark unit 16 in step 132. It should be understood that the downloading of watermarks not necessarily must occur after the downloading of the content item. In reality the downloading of watermarks and content would be done in parallel.

When the complete content item, including watermarks, has been downloaded it is time for the clients 4, 18, 20 to make their claims for the amount of data that they have uploaded in order to earn credits. This is done in step 134. As mentioned above this claiming can also be done every 5 minutes and thus in parallel with many of the steps described above.

It shall be understood that even if the invention has been described with reference to preferred embodiments the invention is not limited thereto. There are many other embodiments and variations that are likewise within the scope of the invention, which is best defined by the accompanying claims.

1. A method for distributing a content item, which has been divided into a plurality of blocks of data, to at least one client connected to a peer-to-peer network, comprising the steps of,
creating at least one watermark block that is unique for the client and the content item to be distributed and storing it in a dedicated storing unit,
issuing a ticket to the client, which is valid both for downloading and uploading,
sending a list to the client identifying other clients that also are interested in receiving the content item,
connecting to selected clients identified on the list,
transferring the plurality of blocks of data from the selected clients to the client and
transferring the at least one watermark block from the dedicated storing unit to the client and
if the complete content item has been downloaded issue a new ticket for the client, which is valid only for uploading.

2. Method according to claim 1, wherein the step of creating at least one watermark block further comprises the steps of,
assigning at least one of the blocks of data to be a watermark,
dividing the at least one watermark block into a plurality of watermark pieces, and
adding a unique watermark to each watermark piece.

3. Method according to claim 2, wherein the step of dividing the watermark block comprises the step of dividing the watermark block into 10-30 watermark pieces, preferably 20 watermark pieces.

4. Method according to claim 1, wherein the step of issuing a ticket to the client further comprises the steps of
receiving a request from the client for the content item,
verifying and authorizing the request from the client, and
sending a ticket to the client.

5. Method according to claim 1, wherein the step of connecting to selected clients identified on the list further comprises the step of verifying that the selected clients have a valid ticket.

6. Method according to claim 1, further comprising the step of requesting credits for data blocks that the client has uploaded.

7. A system for distributing a content item, which has been divided into a plurality of blocks of data, to at least one client connected to a peer-to-peer network, comprising, a control unit for creating at least one watermark block that is unique for the client and the content item, a dedicated storage unit for storing the watermark block, a ticket granter for issuing a ticket to the client, which is valid both for downloading and uploading and if the complete content item has been downloaded issuing a new ticket for the client, which is valid only for uploading, and a tracker for identifying other clients that also are interested in receiving the content item.

8. A system according to claim 7, further comprising a portal configured to display downloadable content items.

9. A system according to claim 7, further comprising a content server for storing content items.

10. A system according to claim 7, further comprising a claim receptor for managing credits for data blocks that the client has uploaded.

11. A computer program comprising code means for performing the steps of claim 1, when the program is run on a computer.

12. A computer program product comprising program code means stored on a computer readable medium for performing the method of claim 1, when said product is run on a computer.
